(19) United States
(12) Patent Application Publication
(10) Pub. No.: US 2013/0043409 A1
(43) Pub. Date: Feb. 21, 2013

(54) METHOD AND APPARATUS FOR TREATING MAGNETIC RECORDING MEDIUM WITH ULTRAVIOLET RADIATION

(71) Applicants: Takako MATSUMOTO, Matsumoto-city (JP); Kenji Hishinuma, Hino-city (JP); Yoshinori Ozawa, Nagano (JP)

(72) Inventors: Takako MATSUMOTO, Matsumoto-city (JP); Kenji Hishinuma, Hino-city (JP); Yoshinori Ozawa, Nagano (JP)

(73) Assignee: FUJI ELECTRIC CO., LTD., Kawasaki-shi (JP)

(21) Appl. No.: 13/569,875

(22) Filed: Aug. 8, 2012

(30) Foreign Application Priority Data
Aug. 16, 2011 (JP) 2011-177923

(51) Int. Cl. B01J 19/12

(52) U.S. Cl. 250/492.1

(57) ABSTRACT

A method and an apparatus for treating multiple magnetic recording media with ultraviolet radiation from a UV lamp stored in an UV lamp house. The media are stored in a cassette and are individually placed in the UV lamp house for irradiation. Each of the media has a magnetic film, a protective film, and a lubricant film on a non-magnetic substrate. A curtain shields the inside of the UV lamp house from air exterior to the UV lamp house while the media are inserted and removed respectively into and from the UV lamp house. The cassette is set at a distance from the curtain that is within the range of 6 mm to 13 mm while the media are irradiated in the UV lamp house.

### CROSS-REFERENCE TO RELATED APPLICATION

This application claims the benefit of priority of Japanese patent application number 2011-177923, filed on Aug. 16, 2011, the disclosure of which is incorporated herein by reference.

### BACKGROUND OF THE INVENTION

1. Field of the Invention

The present invention relates to a method and apparatus for treating a magnetic recording medium with ultraviolet radiation. Particularly, the present invention relates to a method and apparatus for treating a magnetic recording medium used in, for example, an external storage device or the like of a computer by using ultraviolet radiation.

2. Description of the Related Art

Lubricants for use in magnetic recording media, particularly in magnetic disks, have been developed in order to improve the durability and reliability of a magnetic recording medium by reducing a frictional force generated between a protective film of the magnetic recording medium and a magnetic head.

For example, attempts have conventionally been made to improve the lubrication characteristics of the surface layer of a magnetic disk: forming a diamond-like carbon (DLC) protective film as the surface layer and then forming on this protective film a perfluoropolyether lubricant film having a polar end group, such as a hydroxyl group, or a cyclic triphosphazene end group.

The lubricant film on the protective film consists of two layers: a layer bound to the protective layer (referred to as “bonded lubricant layer,” hereinafter), and a layer not bound to the protective layer (referred to as “free lubricant layer,” hereinafter). It is appropriate, from the perspective of the improvement of the lubrication characteristics, that the lubricant film has a thin free lubricant layer and a thick bonded lubricant layer.

However, with the recent growth in density of the magnetic disks, demands for the lubrication characteristics are becoming more and more difficult. In the future, therefore, it is inevitable to increase the maximum film thickness of the bonded lubricant layer.

Moreover, the recent hard disk drives are becoming more and more versatile, ranging from personal computers used indoors, to portable devices and car navigation systems used outdoors. Especially in an environment with high temperature and high humidity where the moisture contained in the highly humid air adheres to the disks of a hard disk drive, the moisture inhibits the magnetic head slider from floating above the disks. The problem, therefore, is how to form the lubricant film on the surface of each magnetic disk more precisely.

Increasing the film thickness of the bonded lubricant layer has been proposed as a method for solving the problem described above. In order to increase the film thickness of the bonded lubricant layer, it is said to be effective to treat each magnetic disk using ultraviolet radiation during the formation of the bonded lubricant layer. In this UV treatment, instead of treating the magnetic disks one by one, the whole cassette storing the magnetic disks (e.g., a whole stack of twenty-five magnetic disks) needs to be treated, in order to improve the efficiency of the treatment and due to the steps prior to and subsequent to the UV treatment.

However, the problem in treating the whole cassette is that the film thickness of the bonded lubricant layers within the cassette varies because the waiting time of each magnetic disk for waiting to be UV-treated under a UV lamp house of an apparatus varies. Especially when treating the whole cassette with ultraviolet radiation, the ultraviolet radiation of the UV lamp house leak out of the magnetic disk slot during the waiting time, and these indirect ultraviolet radiation cannot be controlled, forming the bonded lubricant layers outside the range of the direct UV radiation. In this case, unfortunately, the film thickness of each bonded lubricant layer formed by the indirect ultraviolet radiation cannot be controlled because a conventional process controls only the irradiation time of the direct ultraviolet radiation. For this reason, the variation in film thickness of the bonded lubricant layers of the cassette cannot be controlled.

Therefore, it is necessary to find a method for treating a magnetic recording medium to make the film thickness of the bonded lubricant layers become constant in the UV treatment.

### SUMMARY OF THE INVENTION

The present invention was contrived in view of the problems described above, and an object thereof is to reduce variation in film thickness of lubricant layers of magnetic recording media and to provide magnetic recording media respectively having lubricant layers of even thickness.

In some embodiments, a method for treating a magnetic recording medium with ultraviolet radiation from a UV lamp stored in a UV lamp house is provided. The magnetic recording medium is stored in a cassette and has a magnetic film, a protective film, and a lubricant film on a non-magnetic substrate. A curtain is provided for shielding the inside of the UV lamp house from air exterior to the UV lamp house when inserting and removing the magnetic recording medium respectively into and from the UV lamp house. The method includes setting the cassette at a distance from the curtain that is within the range of 6 mm to 13 mm. The method further includes placing the magnetic recording medium within the UV lamp house. The magnetic recording medium is irradiated with the UV lamp while the cassette is disposed at the set distance.

In some embodiments, an apparatus for treating a magnetic recording medium having a magnetic film, a protective film, and a lubricant film on a non-magnetic substrate, by using ultraviolet radiation is provided. The apparatus includes a cassette for storing the magnetic recording medium therein. The apparatus further includes a UV lamp for treating the magnetic recording medium with the ultraviolet radiation. A UV lamp house for storing the UV lamp therein is also provided. The apparatus has a curtain for shielding the inside of the UV lamp house from air exterior to the UV lamp house when inserting and removing the magnetic recording medium respectively into and from the UV lamp house. When the magnetic recording medium is being treated by the UV lamp a distance between the cassette and the curtain set to be within the range of 6 mm to 13 mm.

The present invention can reduce variation in film thickness of lubricant layers of magnetic recording media, and can provide magnetic recording media respectively having lubricant layers of even thickness.

### BRIEF DESCRIPTION OF THE DRAWINGS

FIG. 1 is a schematic diagram showing an example of an apparatus used favorably in the present invention;

FIG. 2 shows the results of measuring the variation of a bonded ratio within a cassette when a 95-mm diameter magnetic disk is used as a magnetic recording medium; and

FIG. 3 shows the results of measuring the variation of a bonded ratio within a cassette when a 65-mm diameter magnetic disk is used as the magnetic recording medium.

### DESCRIPTION OF THE PREFERRED EMBODIMENTS

The method for treating a magnetic recording medium with ultraviolet radiation is a method for using ultraviolet radiation to treat a magnetic recording medium having a magnetic film, a protective film, and a lubricant film on a non-magnetic substrate. An ordinary non-magnetic substrate, magnetic film, and protective film can be used as the non-magnetic substrate, the protective film, and the protective film.

The method according to the present invention includes a step of preparing a cassette for storing the magnetic recording medium therein, a UV lamp for treating the magnetic recording medium with ultraviolet radiation, a UV lamp house for storing the UV lamp therein, and a curtain for shielding the inside of the UV lamp house from air exterior to the UV lamp house when inserting and removing the magnetic recording medium respectively into and from of the UV lamp house, and an irradiation step of irradiating the magnetic recording medium with the UV lamp. The irradiation step is carried out under a condition that the distance between the cassette and the curtain is within the range of 6 mm to 13 mm. Having a distance not less than 6 mm between the cassette and the curtain achieves the effect of preventing the cassette and the curtain from coming into contact with each other, and keeping the distance not more than 13 mm can achieve the effect of not having the time taken to replace a magnetic disk affect the entire processing time, the time taken to replace a magnetic disk being included in time required in the ultraviolet radiation.

A preferred lubricant used in the present invention includes a perfluoropolyether main chain, as shown in the following chemical formulas 1 and 2, wherein at least one of the ends R₁, R₂, and R₃ has a plurality of functional groups and a molecular weight of 500 to 10,000.

R₁—(CF₂CF₂O)ₚ—(CF₂O)_{q}—R₂ [C 1]

(where p and q are positive integers)

F—(CF₂CF₂CF₂O)ᵣ—R₃ [C 2]

(where r is a positive integer)

In the end structures illustrated above, it is preferred that each functional group be selected from any one of or more than one of the following: hydroxyl group, carboxyl group, aldehyde group, primary and secondary amine groups, nitro group, nitrile group, isonitrile group, isocyanato group, thiol group, sulfo group, and heterocycle. An additive may be added to the lubricant, in which case, as well, the effects of the present invention can be achieved.

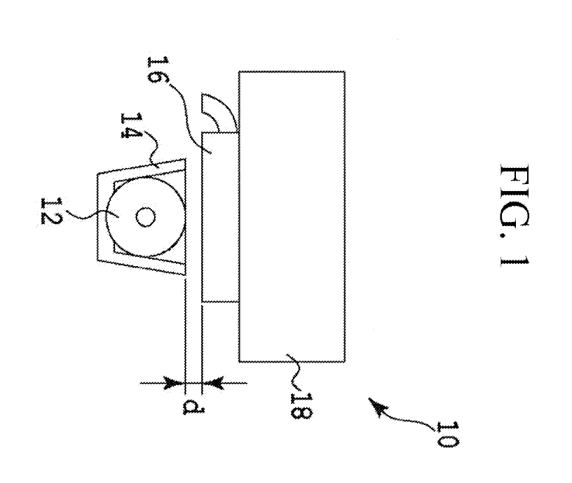

FIG. 1 is a schematic diagram showing an example of an apparatus used favorably in the present invention. In FIG. 1, an apparatus 10 has a magnetic disk 12 (a typical example of the magnetic recording medium), cassette 14, curtain 16, and UV lamp house 18. The magnetic disk 12 is treated with ultraviolet radiation. The cassette 14 is used for storing the magnetic disk 12 and is entirely carried into the apparatus. The curtain 16 is located where the magnetic disk 12 stored in the cassette 14 is brought into the UV lamp house 18. The UV lamp house 18 is attached with the curtain 16 in the vicinity of the cassette 14 to take the magnetic disk 12 in and out of the UV lamp house 18.

A distance d between the cassette and the curtain in the present invention represents the distance between an upper end of the cassette 14 and a lower end of the curtain 16 of the UV lamp house 18, as shown in FIG. 1. Direct light irradiates the magnetic disk 12 when the magnetic disk 12 leaves the cassette 14 and enters the UV lamp house 18, whereas indirect light irradiates the magnetic disk 12 when the magnetic disk 12 remains inside the cassette 14 and does not enter the UV lamp house 18. When the magnetic disk 12 enters the UV lamp house 18, the direct light of a UV lamp (not shown) installed in the UV lamp house 18 emits ultraviolet radiation.

According to a method for controlling the formation of a bonded lubricant layer attributed to the indirect ultraviolet radiation, the amount of the indirect ultraviolet radiation irradiating the magnetic disk 12 is controlled by bringing the cassette 14 and the curtain 16 of the UV lamp house 18 close to each other. Process control of the direct ultraviolet radiation alone can control the variation in film thickness of the bonded lubricant layer of the magnetic disk 12 stored in the cassette 14.

The present invention is used typically when treating the magnetic recording medium with ultraviolet radiation in the cassette after applying the lubricant onto the protective layer, so that the variation in film thickness of the bonded lubricant layer of the magnetic recording medium can be diminished.

### EXAMPLE

An example of the present invention is described hereinafter. The example merely illustrates a typical example of the present invention; thus, the present invention should not be limited to the illustration of the example.

Z-Tetraol (produced by Solvay Solexis) having a —OH end group was used as the lubricant. The UV treatment was performed with different distances between the cassette and the curtain of the UV lamp house to examine the variation in film thickness of the bonded lubricant layer in the cassette.

[Application of Lubricant to Magnetic Recording Medium, and Evaluation of Properties of Lubricant]

1. Sample Preparation—Application of Lubricant

An amorphous carbon protective film having a film thickness of 2.0 nm was formed according to a plasma CVD method and applied to a 65-mm diameter magnetic disk substrate and a 95-mm diameter magnetic disk substrate. These magnetic disk substrates were applied with the abovementioned lubricant mixture by a dip method. Specifically, each magnetic disk substrate was soaked in the lubricant mixture having Vertrel XF (produced by Du-Pont Mitsui Fluorochemicals) as a solvent for 72 seconds, pulled out of the mixture at 1.5 mm/sec, and then dried, to create a magnetic disk. The disk was placed in the measurement position, and dummy disks were placed in other positions, so that there would always be a total of twenty-five disks to be treated with the ultraviolet radiation. After the lubricant mixture was applied to the magnetic disk sample, the magnetic disk was treated with the ultraviolet radiation for 8 seconds by a 200 W UV lamp with a wavelength of 185 nm/254 nm.

The film thickness of the lubricant layer of the sample prepared in the manner described above was measured by a Fourier transform infrared spectrophotometer (FT-IR). The magnetic disk sample was prepared such that the target film thickness of the lubricant layer is based on the followings: the total film thickness is 8.00 Å, the film thickness of the bonded lubricant layer is 6.00 Å, and the bonded ratio is 75.0%.

The abovementioned terms “total film thickness,” “film thickness of the bonded lubricant layer,” and “bonded ratio” are described below.

The bonded ratio between the functional groups existing on the carbon surface and the lubricant is generally represented as a ratio of the film thickness of the lubricant layer rinsed with a fluorinated solvent to the film thickness of the lubricant layer obtained before being rinsed with the fluorinated solvent. The percentage of it is called “bonded ratio.”

Bonded ratio (%)=Film thickness of lubricant layer after rinsing/Film thickness of lubricant layer before rinsing×100 [E 1]

The film thickness of the lubricant layer before rinsing is referred to as “total film thickness,” and the film thickness of the lubricant layer after rinsing is referred to as “film thickness of the bonded lubricant layer.” The “film thickness of the bonded lubricant layer” represents the film thickness (amount) of the lubricant layer actually bonded to the carbon surface.

Vertrel XF (produced by Du-Pont Mitsui Fluorochemicals) is generally used as the fluorinated solvent. Therefore, this solvent was used in this evaluation.

2. Evaluation of Film Thickness of Bonded Lubricant Layer

The sample prepared by the process described above was treated with the ultraviolet radiation, with different distances between the cassette and the curtain of the UV lamp house, and the bonded ratio (the variation in film thickness of the bonded lubricant layer in the cassette) was measured. The distance between the cassette and the magnetic disk was approximately 5 mm, and the distance between the curtain and the UV lamp was 1.5 cm when prototypes 1 and 2 were used.

In this experiment, the evaluation was carried out on each sample by changing the level of the cassette using the apparatus shown in FIG. 1. Table 1 below shows the distances between the upper end of the cassette and the lower end of the curtain.

TABLE 1
Distances between the upper end of the cassette
and the lower end of the curtain (unit: mm)

| | 2.5″ | 3.5″ |
|---|---|---|
| Prototype 1 | 62 | 34 |
| Prototype 2 | 42 | 6 |

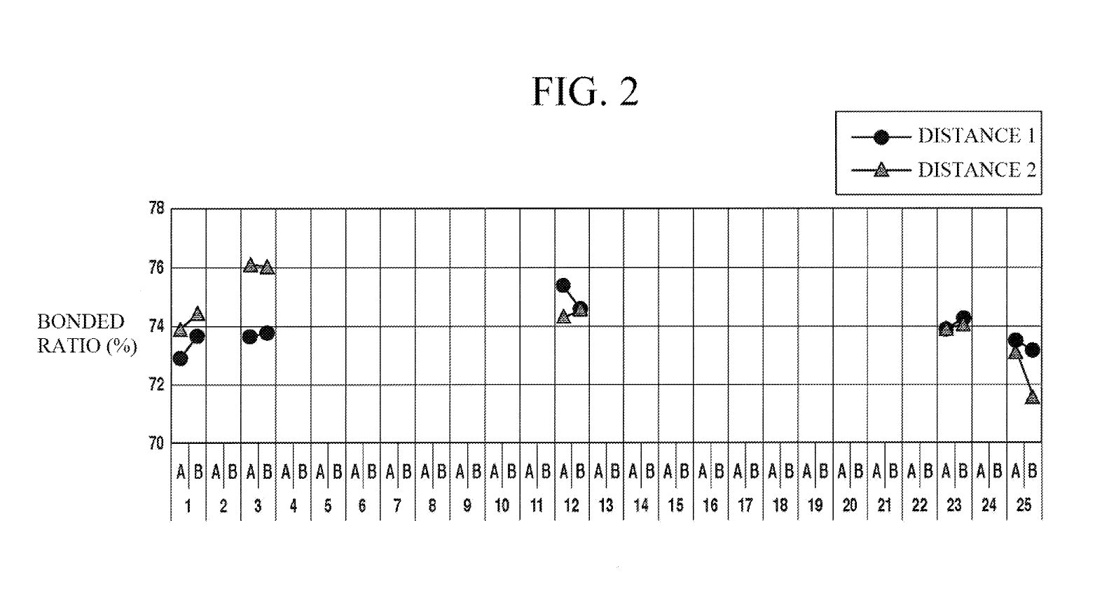

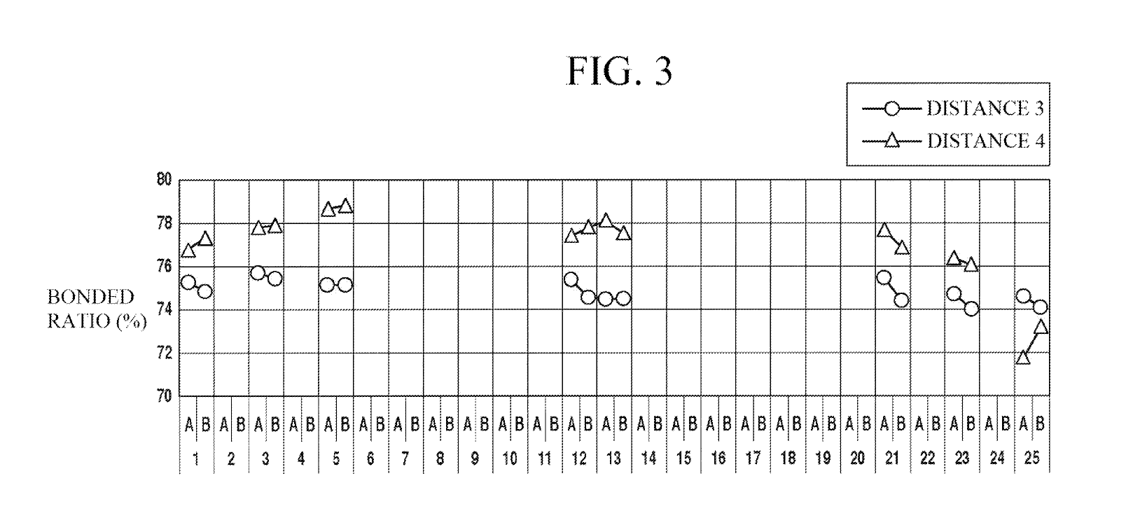

FIG. 2 is a graph showing the bonded ratios of the 65-mm (2.5″) diameter magnetic disk. FIG. 3 is a graph showing the bonded ratios of the 95-mm (3.5″) diameter magnetic disk. The data obtained from FIGS. 2 and 3 are shown in Tables 2 to 5.

TABLE 2
2.5″ footprint was used (Distance: 29 mm), Lane 2 (Data of Distance 1)
PFPE Ave. value

| | | | | | After UV irradiation | | | | After rinsing | | | | Bonded ratio | | | | 0/180 degree |
|---|---|---|---|---|---|---|---|---|---|---|---|---|---|---|---|---|---|
| UV Pos | | UV | Rinse | B.R. | 0° | 90° | 180° | 270° | 0° | 90° | 180° | 270° | 0° | 90° | 180° | 270° | difference |
| 1 | A | 8.08 | 5.90 | 72.94 | 8.03 | 8.16 | 8.05 | 8.09 | 5.93 | 5.92 | 5.76 | 5.97 | 73.85 | 72.55 | 71.55 | 73.79 | 2.30 |
| | B | 8.08 | 5.96 | 73.70 | 7.93 | 8.20 | 8.08 | 8.11 | 5.87 | 6.09 | 5.82 | 6.04 | 74.02 | 74.27 | 72.03 | 74.48 | 1.99 |
| 2 | A | | | | | | | | | | | | | | | | |
| | B | | | | | | | | | | | | | | | | |
| 3 | A | 8.10 | 5.96 | 73.66 | 8.06 | 8.10 | 8.12 | 8.10 | 6.04 | 6.03 | 5.84 | 5.94 | 74.94 | 74.44 | 71.92 | 73.33 | 3.02 |
| | B | 8.10 | 5.98 | 73.79 | 7.92 | 8.18 | 8.20 | 8.11 | 5.97 | 5.98 | 5.90 | 6.06 | 75.38 | 73.11 | 71.95 | 74.72 | 3.43 |
| 4 | A | | | | | | | | | | | | | | | | |
| | B | | | | | | | | | | | | | | | | |
| 5 | A | | | | | | | | | | | | | | | | |
| | B | | | | | | | | | | | | | | | | |
| 6 | A | | | | | | | | | | | | | | | | |
| | B | | | | | | | | | | | | | | | | |
| 7 | A | | | | | | | | | | | | | | | | |
| | B | | | | | | | | | | | | | | | | |
| 8 | A | | | | | | | | | | | | | | | | |
| | B | | | | | | | | | | | | | | | | |
| 9 | A | | | | | | | | | | | | | | | | |
| | B | | | | | | | | | | | | | | | | |
| 10 | A | | | | | | | | | | | | | | | | |
| | B | | | | | | | | | | | | | | | | |
| 11 | A | | | | | | | | | | | | | | | | |
| | B | | | | | | | | | | | | | | | | |
| 12 | A | 8.05 | 6.07 | 75.38 | 7.95 | 8.06 | 8.04 | 8.15 | 6.12 | 6.01 | 5.95 | 6.19 | 76.98 | 74.57 | 74.00 | 75.95 | 2.98 |
| | B | 8.07 | 6.02 | 74.60 | 7.98 | 8.06 | 8.09 | 8.15 | 6.05 | 6.05 | 5.88 | 6.10 | 75.81 | 75.06 | 72.68 | 74.85 | 3.13 |
| 13 | A | | | | | | | | | | | | | | | | |
| | B | | | | | | | | | | | | | | | | |
| 14 | A | | | | | | | | | | | | | | | | |
| | B | | | | | | | | | | | | | | | | |
| 15 | A | | | | | | | | | | | | | | | | |
| | B | | | | | | | | | | | | | | | | |
| 16 | A | | | | | | | | | | | | | | | | |
| | B | | | | | | | | | | | | | | | | |
| 17 | A | | | | | | | | | | | | | | | | |
| | B | | | | | | | | | | | | | | | | |
| 18 | A | | | | | | | | | | | | | | | | |
| | B | | | | | | | | | | | | | | | | |
| 19 | A | | | | | | | | | | | | | | | | |
| | B | | | | | | | | | | | | | | | | |
| 20 | A | | | | | | | | | | | | | | | | |
| | B | | | | | | | | | | | | | | | | |
| 21 | A | | | | | | | | | | | | | | | | |
| | B | | | | | | | | | | | | | | | | |
| 22 | A | | | | | | | | | | | | | | | | |
| | B | | | | | | | | | | | | | | | | |
| 23 | A | 8.08 | 5.97 | 73.84 | 8.12 | 8.12 | 8.15 | 7.94 | 6.02 | 5.98 | 5.87 | 6.00 | 74.14 | 73.65 | 72.02 | 75.57 | 2.11 |
| | B | 8.04 | 5.97 | 74.22 | 7.98 | 7.96 | 8.07 | 8.14 | 5.99 | 6.02 | 5.82 | 6.03 | 75.06 | 75.63 | 72.12 | 74.08 | 2.94 |
| 24 | A | | | | | | | | | | | | | | | | |
| | B | | | | | | | | | | | | | | | | |
| 25 | A | 8.04 | 5.91 | 73.49 | 7.94 | 7.95 | 8.23 | 8.04 | 5.88 | 5.86 | 5.91 | 5.98 | 74.06 | 73.71 | 71.81 | 74.38 | 2.24 |
| | B | 8.05 | 5.88 | 73.13 | 7.93 | 7.95 | 8.25 | 8.05 | 5.89 | 5.81 | 5.93 | 5.90 | 74.27 | 73.08 | 71.88 | 73.29 | 2.40 |

TABLE 3
2.5″ footprint was used (Distance: 29 mm), Lane 4 (Data of Distance 2)
PFPE Ave. value

| | | | | | After UV irradiation | | | | After rinsing | | | | Bonded ratio | | | | 0/180 degree |
|---|---|---|---|---|---|---|---|---|---|---|---|---|---|---|---|---|---|
| UV Pos | | UV | Rinse | B.R. | 0° | 90° | 180° | 270° | 0° | 90° | 180° | 270° | 0° | 90° | 180° | 270° | difference |
| 1 | A | 8.22 | 8.08 | 73.89 | 8.07 | 8.22 | 8.29 | 8.31 | 6.01 | 6.08 | 6.01 | 6.20 | 74.47 | 73.97 | 72.50 | 74.61 | 1.98 |
| | B | 8.18 | 8.09 | 74.47 | 8.06 | 8.15 | 8.27 | 8.25 | 6.13 | 6.08 | 6.03 | 6.13 | 76.05 | 74.60 | 72.91 | 74.30 | 3.14 |
| 2 | A | | | | | | | | | | | | | | | | |
| | B | | | | | | | | | | | | | | | | |
| 3 | A | 8.18 | 6.23 | 76.11 | 8.04 | 8.21 | 8.30 | 8.17 | 6.18 | 6.21 | 6.22 | 6.29 | 76.87 | 75.64 | 74.94 | 76.99 | 1.93 |
| | B | 8.20 | 6.24 | 76.04 | 8.08 | 8.19 | 8.29 | 8.24 | 6.16 | 6.32 | 6.24 | 6.22 | 76.24 | 77.17 | 75.27 | 75.49 | 0.97 |
| 4 | A | | | | | | | | | | | | | | | | |
| | B | | | | | | | | | | | | | | | | |
| 5 | A | | | | | | | | | | | | | | | | |
| | B | | | | | | | | | | | | | | | | |
| 6 | A | | | | | | | | | | | | | | | | |
| | B | | | | | | | | | | | | | | | | |
| 7 | A | | | | | | | | | | | | | | | | |
| | B | | | | | | | | | | | | | | | | |
| 8 | A | | | | | | | | | | | | | | | | |
| | B | | | | | | | | | | | | | | | | |
| 9 | A | | | | | | | | | | | | | | | | |
| | B | | | | | | | | | | | | | | | | |
| 10 | A | | | | | | | | | | | | | | | | |
| | B | | | | | | | | | | | | | | | | |
| 11 | A | | | | | | | | | | | | | | | | |
| | B | | | | | | | | | | | | | | | | |
| 12 | A | 8.32 | 6.18 | 74.31 | 8.09 | 8.65 | 8.46 | 8.07 | 6.13 | 6.45 | 6.17 | 5.97 | 75.77 | 74.57 | 72.93 | 73.98 | 2.84 |
| | B | 8.21 | 6.13 | 74.59 | 8.12 | 8.22 | 8.31 | 8.20 | 6.15 | 6.06 | 6.12 | 6.17 | 75.74 | 73.72 | 73.65 | 75.24 | 2.09 |
| 13 | A | | | | | | | | | | | | | | | | |
| | B | | | | | | | | | | | | | | | | |
| 14 | A | | | | | | | | | | | | | | | | |
| | B | | | | | | | | | | | | | | | | |
| 15 | A | | | | | | | | | | | | | | | | |
| | B | | | | | | | | | | | | | | | | |
| 16 | A | | | | | | | | | | | | | | | | |
| | B | | | | | | | | | | | | | | | | |
| 17 | A | | | | | | | | | | | | | | | | |
| | B | | | | | | | | | | | | | | | | |
| 18 | A | | | | | | | | | | | | | | | | |
| | B | | | | | | | | | | | | | | | | |
| 19 | A | | | | | | | | | | | | | | | | |
| | B | | | | | | | | | | | | | | | | |
| 20 | A | | | | | | | | | | | | | | | | |
| | B | | | | | | | | | | | | | | | | |
| 21 | A | | | | | | | | | | | | | | | | |
| | B | | | | | | | | | | | | | | | | |
| 22 | A | | | | | | | | | | | | | | | | |
| | B | | | | | | | | | | | | | | | | |
| 23 | A | 8.21 | 6.07 | 73.89 | 8.10 | 8.21 | 8.30 | 8.24 | 6.11 | 6.01 | 5.94 | 6.21 | 75.43 | 73.20 | 71.57 | 75.36 | 3.87 |
| | B | 8.20 | 6.07 | 74.00 | 8.07 | 8.18 | 8.28 | 8.27 | 6.05 | 6.18 | 5.92 | 6.12 | 74.97 | 75.55 | 71.50 | 74.00 | 3.47 |
| 24 | A | | | | | | | | | | | | | | | | |
| | B | | | | | | | | | | | | | | | | |
| 25 | A | 8.21 | 6.00 | 73.07 | 8.03 | 8.30 | 8.26 | 8.23 | 5.97 | 6.06 | 5.94 | 6.01 | 74.35 | 73.01 | 71.91 | 73.03 | 2.43 |
| | B | 8.22 | 5.88 | 71.52 | 8.04 | 8.17 | 8.32 | 8.33 | 5.83 | 5.84 | 5.87 | 5.96 | 72.51 | 71.48 | 70.55 | 71.55 | 1.96 |

TABLE 4
Bonded ratio of 3.5″ type magnetic disk by UV Pos (Data of Distance 3)
PFPE Ave. value R30 4 point value

| | | | | | After UV irradiation | | | | After rinsing | | | | Bonded ratio | | | | 0/180 degree |
|---|---|---|---|---|---|---|---|---|---|---|---|---|---|---|---|---|---|
| UV Pos | | UV | Rinse | B.R. | 0° | 90° | 180° | 270° | 0° | 90° | 180° | 270° | 0° | 90° | 180° | 270° | difference |
| 1 | A | 7.43 | 5.59 | 75.27 | 7.44 | 7.53 | 7.37 | 7.38 | 5.59 | 5.70 | 5.47 | 5.61 | 75.13 | 75.70 | 74.22 | 76.02 | 0.91 |
| | B | 7.40 | 5.54 | 74.85 | 7.42 | 7.23 | 7.45 | 7.48 | 5.58 | 5.44 | 5.50 | 5.62 | 75.20 | 75.24 | 73.83 | 75.13 | 1.38 |
| 2 | A | | | | | | | | | | | | | | | | |
| | B | | | | | | | | | | | | | | | | |
| 3 | A | 7.44 | 5.63 | 75.69 | 7.27 | 7.42 | 7.58 | 7.50 | 5.56 | 5.61 | 5.56 | 5.80 | 76.48 | 75.61 | 73.35 | 77.33 | 3.13 |
| | B | 7.40 | 5.58 | 75.43 | 7.33 | 7.50 | 7.38 | 7.37 | 5.69 | 5.57 | 5.46 | 5.59 | 77.63 | 74.27 | 73.98 | 75.85 | 3.64 |
| 4 | A | | | | | | | | | | | | | | | | |
| | B | | | | | | | | | | | | | | | | |
| 5 | A | 7.44 | 5.59 | 75.12 | 7.38 | 7.56 | 7.42 | 7.38 | 5.57 | 5.67 | 5.44 | 5.66 | 75.47 | 75.00 | 73.32 | 76.69 | 2.16 |
| | B | 7.41 | 5.57 | 75.11 | 7.38 | 7.40 | 7.44 | 7.43 | 5.57 | 5.68 | 5.48 | 5.54 | 75.47 | 76.76 | 73.66 | 74.56 | 1.82 |
| 6 | A | | | | | | | | | | | | | | | | |
| | B | | | | | | | | | | | | | | | | |
| 7 | A | | | | | | | | | | | | | | | | |
| | B | | | | | | | | | | | | | | | | |
| 8 | A | | | | | | | | | | | | | | | | |
| | B | | | | | | | | | | | | | | | | |
| 9 | A | | | | | | | | | | | | | | | | |
| | B | | | | | | | | | | | | | | | | |
| 10 | A | | | | | | | | | | | | | | | | |
| | B | | | | | | | | | | | | | | | | |
| 11 | A | | | | | | | | | | | | | | | | |
| | B | | | | | | | | | | | | | | | | |
| 12 | A | 7.47 | 5.63 | 75.32 | 7.38 | 7.51 | 7.59 | 7.40 | 5.59 | 5.64 | 5.56 | 5.71 | 75.75 | 75.10 | 73.25 | 77.16 | 2.49 |
| | B | 7.45 | 5.55 | 74.51 | 7.36 | 7.49 | 7.46 | 7.47 | 5.53 | 5.68 | 5.40 | 5.58 | 75.14 | 75.83 | 72.39 | 74.70 | 2.75 |
| 13 | A | 7.44 | 5.54 | 74.44 | 7.42 | 7.58 | 7.28 | 7.46 | 5.53 | 5.68 | 5.32 | 5.61 | 74.53 | 74.93 | 73.08 | 75.20 | |
| | B | 7.42 | 5.53 | 74.47 | 7.34 | 7.36 | 7.48 | 7.51 | 5.52 | 5.51 | 5.47 | 5.61 | 75.20 | 74.86 | 73.13 | 74.70 | |
| 14 | A | | | | | | | | | | | | | | | | |
| | B | | | | | | | | | | | | | | | | |
| 15 | A | | | | | | | | | | | | | | | | |
| | B | | | | | | | | | | | | | | | | |
| 16 | A | | | | | | | | | | | | | | | | |
| | B | | | | | | | | | | | | | | | | |
| 17 | A | | | | | | | | | | | | | | | | |
| | B | | | | | | | | | | | | | | | | |
| 18 | A | | | | | | | | | | | | | | | | |
| | B | | | | | | | | | | | | | | | | |
| 19 | A | | | | | | | | | | | | | | | | |
| | B | | | | | | | | | | | | | | | | |
| 20 | A | | | | | | | | | | | | | | | | |
| | B | | | | | | | | | | | | | | | | |
| 21 | A | 7.43 | 5.60 | 75.38 | 7.25 | 7.45 | 7.43 | 7.60 | 5.53 | 5.65 | 5.44 | 5.79 | 76.28 | 75.84 | 73.22 | 76.18 | 3.06 |
| | B | 7.47 | 5.55 | 74.32 | 7.33 | 7.56 | 7.60 | 7.40 | 5.55 | 5.66 | 5.49 | 5.51 | 75.72 | 74.87 | 72.24 | 74.46 | 3.48 |
| 22 | A | | | | | | | | | | | | | | | | |
| | B | | | | | | | | | | | | | | | | |
| 23 | A | 7.43 | 5.54 | 74.61 | 7.31 | 7.40 | 7.46 | 7.53 | 5.48 | 5.50 | 5.47 | 5.71 | 74.97 | 74.32 | 73.32 | 75.83 | 1.64 |
| | B | 7.50 | 5.54 | 73.95 | 7.41 | 7.87 | 7.55 | 7.35 | 5.52 | 5.74 | 5.47 | 5.44 | 74.49 | 74.84 | 72.45 | 74.01 | 2.04 |
| 24 | A | | | | | | | | | | | | | | | | |
| | B | | | | | | | | | | | | | | | | |
| 25 | A | 7.43 | 5.35 | 74.51 | 7.37 | 7.50 | 7.49 | 7.34 | 5.37 | 5.22 | 5.36 | 5.46 | 72.86 | 69.60 | 71.56 | 74.39 | 1.30 |
| | B | 7.42 | 5.25 | 74.00 | 7.22 | 7.42 | 7.51 | 7.51 | 5.12 | 5.26 | 5.35 | 5.26 | 70.91 | 70.89 | 71.24 | 70.04 | −0.32 |

TABLE 5
Bonded ratio of 2.5″ type magnetic disk by UV Pos (Data of Distance 4)
PFPE Ave. value R30 4 point value

| | | | | | After UV irradiation | | | | After rinsing | | | | Bonded ratio | | | |
|---|---|---|---|---|---|---|---|---|---|---|---|---|---|---|---|---|
| UV Pos | | UV | Rinse | B.R. | 0° | 90° | 180° | 270° | 0° | 90° | 180° | 270° | 0° | 90° | 180° | 270° |
| 1 | A | 8.30 | 6.38 | 76.79 | 8.25 | 8.33 | 8.33 | 8.30 | 6.45 | 6.33 | 6.30 | 6.42 | 78.18 | 75.99 | 75.63 | 77.35 |
| | B | 8.25 | 6.38 | 77.37 | 8.12 | 8.10 | 8.41 | 8.35 | 6.38 | 6.37 | 6.30 | 6.46 | 78.57 | 78.64 | 74.91 | 77.37 |
| 2 | A | | | | | | | | | | | | | | | |
| | B | | | | | | | | | | | | | | | |
| 3 | A | 8.32 | 6.47 | 77.76 | 8.22 | 8.20 | 8.43 | 8.42 | 6.43 | 6.39 | 6.44 | 6.61 | 78.22 | 77.93 | 76.39 | 78.50 |
| | B | 8.26 | 6.43 | 77.86 | 8.19 | 8.30 | 8.32 | 8.24 | 6.47 | 6.50 | 6.33 | 6.43 | 79.00 | 78.31 | 76.08 | 78.03 |
| 4 | A | | | | | | | | | | | | | | | |
| | B | | | | | | | | | | | | | | | |
| 5 | A | 8.29 | 6.51 | 78.61 | 8.21 | 8.22 | 8.37 | 8.34 | 6.51 | 6.48 | 6.49 | 6.57 | 79.29 | 78.83 | 77.54 | 78.78 |
| | B | 8.26 | 6.51 | 78.76 | 8.21 | 8.21 | 8.34 | 8.29 | 6.48 | 6.51 | 6.49 | 6.55 | 78.93 | 79.29 | 77.82 | 79.01 |
| 6 | A | | | | | | | | | | | | | | | |
| | B | | | | | | | | | | | | | | | |
| 7 | A | | | | | | | | | | | | | | | |
| | B | | | | | | | | | | | | | | | |
| 8 | A | | | | | | | | | | | | | | | |
| | B | | | | | | | | | | | | | | | |
| 9 | A | | | | | | | | | | | | | | | |
| | B | | | | | | | | | | | | | | | |
| 10 | A | | | | | | | | | | | | | | | |
| | B | | | | | | | | | | | | | | | |
| 11 | A | | | | | | | | | | | | | | | |
| | B | | | | | | | | | | | | | | | |
| 12 | A | 8.29 | 6.41 | 77.37 | 8.25 | 8.24 | 8.36 | 8.30 | 6.35 | 6.28 | 6.50 | 6.52 | 76.97 | 76.21 | 77.75 | 78.55 |
| | B | 8.22 | 6.39 | 77.74 | 8.16 | 8.21 | 8.21 | 8.29 | 6.42 | 6.43 | 6.38 | 6.32 | 78.68 | 78.32 | 77.71 | 76.24 |
| 13 | A | 8.28 | 6.46 | 78.04 | 8.32 | 8.24 | 8.28 | 8.26 | 6.46 | 6.46 | 6.42 | 6.49 | 77.64 | 78.40 | 77.54 | 78.57 |
| | B | 8.39 | 6.50 | 77.47 | 8.33 | 8.39 | 8.43 | 8.40 | 6.49 | 6.53 | 6.48 | 6.49 | 77.91 | 77.83 | 76.87 | 77.26 |
| 14 | A | | | | | | | | | | | | | | | |
| | B | | | | | | | | | | | | | | | |
| 15 | A | | | | | | | | | | | | | | | |
| | B | | | | | | | | | | | | | | | |
| 16 | A | | | | | | | | | | | | | | | |
| | B | | | | | | | | | | | | | | | |
| 17 | A | | | | | | | | | | | | | | | |
| | B | | | | | | | | | | | | | | | |
| 18 | A | | | | | | | | | | | | | | | |
| | B | | | | | | | | | | | | | | | |
| 19 | A | | | | | | | | | | | | | | | |
| | B | | | | | | | | | | | | | | | |
| 20 | A | | | | | | | | | | | | | | | |
| | B | | | | | | | | | | | | | | | |
| 21 | A | 8.15 | 6.32 | 77.56 | 8.10 | 8.02 | 8.30 | 8.18 | 6.37 | 6.31 | 6.26 | 6.34 | 78.64 | 78.68 | 75.42 | 77.51 |
| | B | 7.94 | 6.09 | 76.76 | 7.82 | 8.04 | 7.97 | 7.91 | 6.10 | 6.15 | 5.92 | 6.19 | 78.01 | 76.49 | 74.28 | 78.26 |
| 22 | A | | | | | | | | | | | | | | | |
| | B | | | | | | | | | | | | | | | |
| 23 | A | 8.26 | 6.30 | 76.29 | 8.12 | 8.20 | 8.35 | 8.35 | 6.31 | 6.16 | 6.30 | 6.42 | 77.71 | 75.12 | 75.45 | 76.89 |
| | B | 8.25 | 6.26 | 75.96 | 8.12 | 8.31 | 8.30 | 8.25 | 6.27 | 6.34 | 6.25 | 6.19 | 77.22 | 76.29 | 75.30 | 75.03 |
| 24 | A | | | | | | | | | | | | | | | |
| | B | | | | | | | | | | | | | | | |
| 25 | A | 8.22 | 5.89 | 71.66 | 8.18 | 8.20 | 8.30 | 8.20 | 6.02 | 5.86 | 5.80 | 5.88 | 73.59 | 71.46 | 69.88 | 71.71 |
| | B | 8.25 | 6.03 | 73.09 | 8.25 | 8.18 | 8.28 | 8.29 | 6.09 | 6.04 | 5.98 | 6.01 | 73.82 | 73.84 | 72.22 | 72.50 |

The distances between the cassette and the curtain of the UV lamp house are as follows: Distance 1>Distance 2, and Distance 3>Distance 4. Distance 1 and Distance 3 are shorter with respect to the UV lamp house.

The actual distances are as follows: Distance 1 is 34 mm, Distance 2 is 6 mm, Distance 3 is 42 mm, and Distance 4 is 6 mm. In Tables 2 to 5, the data on the 2.5″ magnetic disk are acquired by adjusting the distance to 6 mm in the prototype 1 before and after the improvement, and the data of the prototype 1 prior to the improvement and the data of the prototype 2 after the improvement were acquired as the data on the 3.5″ magnetic disk.

According to the data shown in FIG. 2, the variation in bonded ratio in the cassette is 2.4% according to Distance 1 and 4.6% according to Distance 2. This indicates that the variation can be reduced by reducing the distance. The similar improvement can be seen in FIG. 3 as well. That is, the variation is 1.7% according to Distance 3 and 7.1% according to Distance 4. Based on these results, it is understood that the shorter the distance between the cassette and the curtain of the UV lamp house, the more effectively the variation in bonded ratio in the cassette can be reduced, regardless of the size of the magnetic disk.

For instance, in a conventional apparatus, magnetic disks stored in a cassette are lifted up and moved to a UV lamp house one by one and irradiated with light. In the present invention, however, the amount of the indirect ultraviolet radiation leaking out of the slot (the curtain) of the magnetic disks in the UV lamp house is reduced by reducing the distance between the cassette and the curtain of the UV lamp house, so that the magnetic disks that are waiting under the UV lamp house or are obtained after the treatment are prevented from being exposed to the indirect ultraviolet radiation. Because the formation of the bonded layer by the indirect ultraviolet radiation cannot be easily controlled using the process of the apparatus, it needs to be controlled physically. The method practiced above for reducing the distance between the cassette and the curtain of the UV lamp house is extremely effective because the indirect ultraviolet radiation are radiated evenly over the entire magnetic disks stored in the cassette.

Unlike the conventional technology, the present invention is capable of controlling the indirect ultraviolet radiation, reducing the variation in film thickness of the bonded lubricant layers of magnetic recording media, and producing magnetic recording media having lubricant layers of even thickness.

What has been described above includes examples of embodiments represented by the appended claims. It is, of course, not possible to describe every conceivable combination of components or methodologies encompassed by the claims, but it should be understood that many further combinations and permutations are possible. Accordingly, the claims are intended to embrace all such combinations, permutations, alterations, modifications and variations that fall within the spirit and scope of the claims. Moreover, the above description, and the Abstract, are not intended to be exhaustive or to limit the spirit and scope of the claims to the precise forms disclosed.

What is claimed is:

1. A method for treating a plurality of magnetic recording media stored in a cassette with UV radiation from a UV lamp stored in a UV lamp house, each of the media having a magnetic film, a protective film, and a lubricant film on a non-magnetic substrate, the method comprising:
placing one medium of the plurality of media within the house and irradiating the one medium therein by the UV lamp;
removing the irradiated medium from the house;
during said placing and said removing, shielding the inside of the house with a curtain from air exterior to the house; and
during said irradiating, disposing the cassette at a distance from the curtain in the range of 6 mm to 13 mm.

2. The method of claim 1, further comprising:
storing the removed irradiated medium in the cassette;
after said storing, removing another medium of said media from the cassette; and
placing the another medium in the house.

3. The method of claim 2, further comprising irradiating the another medium by the UV lamp while the cassette is disposed at said distance.

4. The method of claim 1, wherein said distance is measured from an upper end of the cassette to a lower end of the curtain.

5. The method of claim 1, wherein the curtain is positioned on the UV lamp house at a point where the medium enters the UV lamp house.

6. The method of claim 5, wherein the UV lamp house is attached to the curtain.

7. An apparatus for treating a plurality of magnetic recording media with UV radiation, each of the media including a magnetic film, a protective film, and a lubricant film on a non-magnetic substrate, the apparatus comprising:
a cassette for storing the media therein;
a UV lamp;
a UV lamp house storing the UV lamp therein, the UV lamp for irradiating one medium of the plurality of the media while disposed within said lamp house; and
a curtain shielding the inside of the UV lamp house from air exterior to the UV lamp house,
wherein a distance between the cassette and the curtain is in the range of 6 mm to 13 mm.

8. The apparatus of claim 7, wherein said distance is measured from an upper end of the cassette to a lower end of the curtain.

9. The apparatus of claim 7, wherein the curtain is positioned on the UV lamp house at a point where the media enter the UV lamp house.

10. The apparatus of claim 9, wherein the UV lamp house is attached to the curtain.

11. The apparatus of claim 7, wherein the apparatus is configured to move the irradiated medium from the UV lamp house to the cassette, and then remove another of the media from the cassette and place the another medium in the UV lamp house.
